(19) United States
(12) Patent Application Publication
(10) Pub. No.: US 2010/0076833 A1
(43) Pub. Date: Mar. 25, 2010

(54) SYSTEMS AND METHODS FOR MANAGING AND USING A VIRTUAL CARD

(75) Inventor: David A. Nelsen, Tigard, OR (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: GIFTANGO CORPORATION, Tigard, OR (US)

(21) Appl. No.: 12/562,091

(22) Filed: Sep. 17, 2009

Related U.S. Application Data
(60) Provisional application No. 61/098,669, filed on Sep. 19, 2008.

(51) Int. Cl. G06Q 30/00; G06Q 40/00

(52) U.S. Cl. 705/14.25; 705/44; 705/27; 705/14.34

(57) ABSTRACT

A virtual card engine stored on memory executable via at least one processor for managing two or more virtual cards is provided. The virtual card engine including a value modification module configured to modify value data corresponding to at least a first virtual card based on user input, send a request to an associated card service provider to modify value data in a corresponding provider-side associative card profile, and present the first virtual card on a display of a mobile computing device to initiate a virtual card transaction between the virtual card engine and the card service provider.

### CROSS-REFERENCE TO RELATED APPLICATIONS

This application claims priority to U.S. Provisional Patent Application No. 61/098,669, filed Sep. 19, 2008 entitled “SYSTEMS AND METHODS FOR MANAGING AND USE OF A VIRTUAL CARD SYSTEM” the entire contents of which are hereby incorporated herein by reference for all purposes.

### FIELD

The present disclosure relates generally to systems and methods to manage and use a virtual card.

### BACKGROUND AND SUMMARY

Plastic gift cards have become a popular form of payment in today's marketplace. Consumers typically purchase a select goods and services system's gift card and then present the plastic gift card to the brick and mortar location for redemption. Many times the purchaser of the gift card carries the gift card in their wallet for a period of time prior to redemption. During redemption, the user must sort through his wallet and hope that the card has not been lost or otherwise misplaced.

As the use of gift cards has become more and more popular, consumers are likely to carry a number of such gift cards in their wallet. Typically, the gift cards are only redeemable at a single goods and services system's establishment or a limited number of goods and services system's establishments. As such, the number of gift cards that are carried and maintained by an individual consumer is significant. A consumer may have similar problems with plastic and paper loyalty cards, such as membership cards, rewards card, points card, advantage cards, and/or club cards. Thus, the use of such cards may further increase consumer's the physical wallet size.

The inventors herein have recognized the difficulties of managing the large number of cards which are maintained by a consumer. Due to the number of these cards that a consumer may manage, consumers may physically stretch their wallets to carry the large number of cards. The consumer may desire to reduce the number of cards that are carried in the physical wallet or purse.

As the inventors herein have recognized the difficulties with the plastic issued cards, alternative methods and systems for electronic cards have been developed. These electronically-issued and managed cards are referred to herein as virtual cards. The virtual card may include, but are not limited to, one or more of a virtual gift card, a virtual loyalty card, a virtual membership card, and/or a virtual rewards card.

As described in more detail below, the inventors herein have provided systems and methods for managing and using the virtual cards. As such, in one example approach, a virtual card engine may be stored on memory executable via at least one processor for managing at least one virtual card. The virtual card engine may include a value modification module configured to modify value data corresponding to at least a first virtual card based on user input, to send a request to an associated card service provider to modify value data in a corresponding provider-side associative card profile, and present the first virtual card on a display of a mobile computing device to initiate a virtual card transaction between the virtual card engine and the card service provider. Other approaches are described in more detail herein.

### BRIEF DESCRIPTION OF THE FIGURES

The disclosure is illustrated by way of example and not by way of limitation in the figures of the accompanying drawings, in which the like references indicate similar elements and in which:

FIG. 1 shows an exemplary schematic illustration of a virtual card management system according to an embodiment of the present disclosure.

FIG. 2 is an example virtual card engine that may be included in the virtual card management system shown in FIG. 1, according to an embodiment of the present disclosure.

FIG. 3 is a process flow for managing a virtual card according to an embodiment of the present disclosure.

FIGS. 4-19 show various examples of a mobile computing device which may present various content windows to enable the functionality of the virtual card engine shown in FIG. 2, according to various embodiments of the present disclosure.

FIG. 20 is a process flow of a method for combining virtual value cards according to an embodiment of the present disclosure.

FIG. 21 is a process flow of a method for splitting a value of a virtual value card according to an embodiment of the present disclosure.

### DETAILED DESCRIPTION

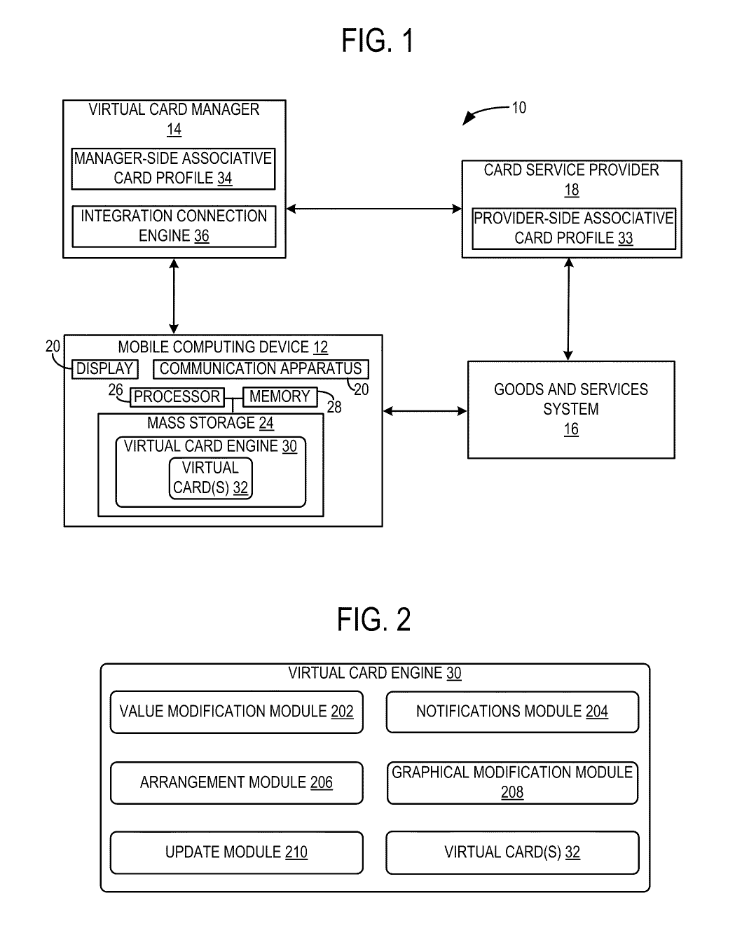

FIG. 1 shows an exemplary schematic illustration of a virtual card management system 10 according to an embodiment of the present disclosure. As described below, the system enables a user of a mobile computing device to manage and use one or more virtual cards.

Virtual card as used herein may be an electronically-issued and/or electronically maintained virtual value card. A virtual value may be any type of privilege, monetary or non-monetary. For example, a virtual value card may be a stored value card which may include, but is not limited to, a virtual gift card, a virtual loyalty card, a virtual rewards card, a prepaid card, or another suitable virtual card that holds prepaid value. The stored value card may have monetary or other forms of value stored on the virtual card. In another example, a virtual value card may be a virtual membership card where such stored value includes membership privileges or identification-related privileges. An example of virtual membership cards may include, but are not limited to, virtual identification cards, club cards, promotional cards, identification cards (ID cards), etc.

As depicted in FIG. 1, virtual card management system 10 may include a mobile computing device 12, a virtual card manager 14, at least one goods and services system 16, and at least one card service provider 18. The mobile computing device may be a suitable computing device that enables a user to store and maintain one or more virtual cards. For example, the mobile computing device may be a smart phone, a handheld computing device, a laptop computer, a portable media player, etc. In some embodiments, the mobile computing device may run an identifiable operating system's software and provide a standardized interface and platform for applications. The mobile computing device may be networked to one or more networks, such as a public network (e.g. the Internet), to enable communication for authentication of the virtual card.

Mobile computing device 12 may include a display 20 configured to present graphics on the device. The mobile computing device may also include a communication apparatus 22 facilitating wired and/or wireless communication between the mobile computing device and external systems and devices (e.g. the virtual card manager, the goods and services system, and the card service provider). As depicted the mobile computing device may include various software applications stored on mass storage 24 and executable via a processor 26 using portions of memory 28. In some embodiments, mass storage 24 may be a hard drive, solid state memory, a rewritable disc, etc. The mass storage 24 may include various programmatic elements such as a virtual card engine 30 configured to manage one or more virtual card(s) 32. The virtual card engine 30 may be a software application configured to implement various virtual card functions, discussed in greater detail herein.

The virtual cards may be virtual value cards, such as virtual gift cards or virtual membership cards, as described above. Each virtual card may include card data such as an identification (ID) number, a stored value, a name, a bar code, image data (e.g. picture of a card holder or other image data), data corresponding to the associated goods and services system through which the card may be used, etc. The virtual card engine may be a software application configured to implement various virtual card functions to enable ease and use of the virtual card. Some of the virtual card functions may be implemented via various modules included in the virtual card engine illustrated in FIG. 2, and described in more detail herein.

It will be appreciated that in some embodiments, a browser-based virtual card engine may be utilized. In other words the virtual card engine may be executed on a remote Internet server accessible via the mobile computing device. In some examples, when a browser-based virtual card engine is used, a card service provider or associated goods and services system may manage various characteristics of the virtual card. However, it will be appreciated that in other embodiments the card service provider may be inhibited from modifying various characteristics of the virtual cards in the virtual card engine.

As used herein, the goods and services system 16 (also referred to generally as the merchant) may be a system configured to manage goods and services transactions. As such, the merchant may be the store selling or providing goods and/or services that desires to have their card data or stored value issued electronically or virtually through a mobile or other electronic device. In other examples, the merchants may include card service providers which may be a third party service or provider that represents a gift card or other card services on behalf of a select merchant. The card service provider may be a third party stored value company, a module or software component of the merchant's existing Point of Sale (POS) software and/or provider, and/or application or software purchased, created, or used by the merchant to track the gift card services on behalf of the merchant.

In some examples, the goods and services system 16 may be configured to virtually or electronically issue card data such as loyalty data, membership data, value data (e.g. monetary data), etc., through a mobile computing device or other electronic device. The goods and services system may include a POS system which may include software and hardware to manage electronic transactions. It will be appreciated that the goods and services system 16 may be associated with one or more merchants. The merchants may include one or more coffee shops, fast food restaurants, hotels, supermarkets, etc. Therefore, the goods and services system 16 may process a transaction at a brick and mortar location, in some examples. However, in other examples the goods and services system 16 may process transactions over the Internet. One type of exemplary transaction may include an electronic transaction, such as a virtual card transaction, discussed in greater detail herein.

One type of exemplary transaction may include an electronic transaction, such as a virtual card transaction. A virtual card transaction may include communication between two systems, devices, etc., in which value and/or privilege data is exchanged and/or manipulated. For example, a virtual card transaction may include deducting value from a virtual card in exchange for a good or service at a merchant location associated with a goods and services system. Further in other examples, a virtual card transaction may include, scanning a virtual membership card at a merchant location associated with a goods and services system and granting access privileges to the merchant location. Further, it will be appreciated that in some examples a transaction may include implementation of security protocols.

In some embodiments, the goods and services system 16 may directly manage and control virtual card transactions. In other words, card service provider 18 may be included in the goods and services system. However, in other examples, the goods and services system may use an external card service provider. Thus, a third party card service provider may be used in some embodiments. The card service provider may enable the goods and services system to perform virtual card transactions. As an example, the third party card service provider may be the software and hardware configured to perform virtual card transactions on behalf of a selected goods and services system. For example, the third party card service provider may include both hardware and software which, among other things, may be configured to electronically process virtual card transactions. It will be appreciated that virtual card transactions may include value transactions, such as monetary transaction in which value of a virtual card is adjusted. Additionally, the virtual card transactions may also include management of electronic privileges (e.g. card holder privileges) such as electronic access to certain types of data. Therefore, a transaction may include communication between two systems, devices, etc., in which value and/or privilege data is exchanged and/or manipulated. For example, a virtual card transaction may include deducting value from a virtual card in exchange for a good or service at a merchant location associated with a goods and services system. Further in other examples a virtual card transaction may include, scanning or otherwise communicating (e.g. NFC—Near Field Communication) a virtual membership card at a merchant location associated with a goods and services system and granting access privileges to the merchant location. Further, it will be appreciated that in some examples a transaction may include implementation of security protocols.

As briefly mentioned above, card service provider 18 may be a third party stored value system or a module or software component of the goods and services system's existing POS system created or used by the goods and services system to track the virtual card services on behalf of the goods and services system. A goods and services system's POS Provider may be software, hardware, and/or other devices configured to process goods and services transactions at a location. Often times the POS may have a module or built in capability, thus making the POS System also a “Card Service Provider”.

Card service provider 18 may be configured to generate at least one provider-side associative card profile 33, each associative card profile corresponding to a virtual card. The provider-side associative card profile may be stored in a provider-side database. The provider-side associative card profile may include virtual card data such as stored value (e.g. monetary value, point value), identification (ID) data (e.g. ID number, personal identification numbers), a card holder's name, etc. A selected provider-side associative card profile may be accessed and adjusted during a virtual card transaction. It will be appreciated that the provider-side associative card profile may be included in the goods and services system, in some embodiments.

In some examples, virtual card manager 14 may be communicatively linked with one or both of mobile computing device 12 and card service provider 18. Additionally, the virtual card manager may include at least one manager-side associative card profile 34. The manager-side associative card profile may be stored in a manager-side database. Furthermore, it will be appreciated that in some embodiments the virtual card manager may also be communicatively linked with goods and services system 16. As such, virtual card manager 14 may be configured to manage a plurality of virtual cards.

The manager-side associative card profile 34 may also include virtual card data such as stored value (e.g. monetary value, point value), identification (ID) data (e.g. ID number, personal identification numbers), a card holder name, etc. A selected manager-side associative card profile may be accessed and adjusted during a virtual card transaction. The provider-side associative card profile 33 with a virtual card's manager-side associative card profile 34.

In one example, virtual card manager 14 may be configured to manage various security features of the virtual cards such as selective enablement (e.g. access control via authentication). For example, use of a virtual card may be selectively enabled (e.g. enabled or disabled). It will be appreciated that the virtual card may have an “activated” status while the virtual card is selectively enabled. Thus, the virtual card may be “activated” but in an enabled or disabled state. In this way, use of the virtual card may be quickly turned “on” and “off” without deactivating the virtual card, thereby enhancing the security of the virtual card when compared to plastic gift cards which remain in an enabled state subsequent to activation.

In some examples, the virtual card manager may include an integration connection engine 36 configured to communicatively link the virtual card manager with at least one card service provider 18 via an API or other software communication standard included in the card service provider. In this way, the virtual card manager may communicate with the card service provider. When a plurality of card service providers are communicatively linked to the virtual card manager at least a portion of the card service providers may utilize different communication protocols, communication hardware, security protocols, etc. Thus, the integration connection engine may enable the virtual card manager to interact with a number of different card service providers. In other embodiments, the card service provider may wish to use an API or other software provided by the virtual card manager to enable communication. In further examples, the card service provider may include other methods or systems for communicating with the virtual card manager.

Additionally, it will be appreciated that the integration connection engine may include one or more virtual card adapters configured to modify the data sent and receive to and from the goods and services system into a common programming language, such as XML. However, in other embodiments the integration connection engine may not include the virtual card adapter.

The virtual card manager may be configured to manage various security features of the virtual cards such as selective enablement (e.g. access control via authentication). Example security features of a virtual card manager are disclosed in provided in U.S. Provisional Application No. 61094654 filed Sep. 5, 2008 entitled Systems and Methods for Periodic Authentication of a Virtual Card, inventor David Nelsen and U.S. application No. filed Sep. 4, 2009 entitled SYSTEMS AND METHODS FOR AUTHENTICATION OF A VIRTUAL STORED VALUE CARD. The disclosures of which are hereby incorporated by reference for all purposes.

Thus, in some examples, a virtual card system may be set up such that a virtual card manager is able to enable and disable a virtual card. A merchant may then be communicatively linked to the virtual card manager. The merchant may be able to select a level of security and/or fraud protection. Depending on the security level, a rule set may be applied for virtual cards associated with the merchant. The rule set will then be applied with use of virtual cards associated with the merchant.

For example, a virtual card may be delivered to a user through a computing device, such as a stationary computing device or a mobile computing device. In one example, the virtual card may be delivered for use to a user's mobile computing device. Predetermined authentication rules, also referred to as security rules, may be associated with the virtual card. The authentication rules may be implemented such that the state of the virtual card (e.g. enabled state, disabled state, etc.) may be managed by the virtual card manager. In some systems, the virtual card manager may be a remote server while in other systems, the virtual card manager may be on the mobile computing device.

As an example, depending on the authentication rules, use of the virtual card may be limited to an identified mobile computing device such that an attempt to use the virtual card from an unidentified (unassociated) mobile computing device is blocked. When such a use is requested, the virtual card may remain in a disabled state, thereby preventing the unauthorized use of the card. Again, depending on the rule set, in some systems, a merchant may be able to over-ride the disabled state if additional identification is provided. Although the above example is described in regards to identification of a single mobile computing device, in some examples, a user may be able to introduce additional computing devices as authorized computing devices. In such systems, the rule set may enable identification of a requesting computing device as an authorized computing device such that the state of the card is enabled.

Although only a single card service provider and mobile computing device are depicted, it will be appreciated that virtual card manager 14 may act as a common platform for managing a large number of virtual cards corresponding to a plurality of card service providers. In some examples, two or more of the card service providers may have different characteristics. For example, two or more of the card service providers may utilize different communication protocols and may be linked to different goods and services systems and therefore provide different services. Furthermore, the card service provider may provide different types of card services. For example, one card service provider may provide membership card services while another card service provider may provide gift card services. In this way, a single virtual card management system can be used to manage a large number of virtual cards, facilitating scalability of the virtual card management system, thereby enhancing the market appeal of the virtual card management system.

FIG. 2 illustrates a detailed schematic depiction of an example virtual card engine 30. As previously discussed, the virtual card engine may be stored on memory executable via at least one processor. Moreover, the virtual card engine may be executed on a mobile computing device or a remote Internet server. In this way, a browser-based or client-based virtual card engine may be utilized.

Furthermore, the virtual card engine may include various modules that enable various virtual card management functions. The modules may include a value modification module 202 configured to modify value data corresponding to at least a first value card based on user input. The value modification module may further be configured to send a request to an associated card service provider to modify value data in a corresponding provider-side associative card profile and present the first virtual value card on a display of a mobile computing device. In some examples, presenting the first virtual value card may initiate a virtual card transaction between the virtual card engine and the card service provider, as previously discussed. Further in some examples, value modification module 202 may be configured to combine two or more virtual value cards. An exemplary method utilized to combine two or more virtual value cards is depicted in FIG. 15. In this way, the value included in two or more virtual value cards may be combined, allowing a user to consolidate a number of virtual values cards included in the virtual card engine.

Value modification module 202 may also be configured to generate a second virtual value card and transfer a portion of the value data onto the second virtual value card. In this way, a virtual value card may be split. Such an operation is not possible with a plastic value card whose value is fixed and cannot be adjusted after generation. Value modification module 202 may further be configured to transfer at least one of the first and second virtual value cards to a second virtual card engine. Thus, a user may be able to send a portion of a virtual card as a gift to another person.

The virtual card engine may further include a notifications module 204 configured to receive and present promotional notifications corresponding to the first virtual value card and an associated card service provider. As discussed above the card service provider may be configured to process a virtual card transaction with the first virtual value card. The promotional notifications may include one or more of a rebate notification and an incentive notification. The rebate notification and/or incentive notification may include one or more of value data, audio data, image data, and alpha-numeric data. It will be appreciated that the value data may be utilized in a virtual card transaction with the card service provider. As previously discussed, a virtual card transaction may include an exchange of value data between the card service provider and the virtual card engine.

It will be appreciated that associated card service provider may be configured to track and store virtual card usage data of least the first virtual value card and generate the one or more promotional notifications based on the usage data of the first virtual value card. The card usage data may include transaction value, transaction location, transaction date, etc. In this way, a client may be provided with promotional notifications that may be customized according to their preferences. Furthermore, when the promotional notifications are generated, the promotional notifications may be transferred to the virtual card manager and then the virtual card engine, in some examples. It will be appreciated that the virtual card engine may receive additional notifications such as security notifications, card expiration notifications, transaction notifications, and merchant-information notifications. Further, it is noted that promotions may be generated by a third party provider, the merchant, and/or the card service provider. As an example, and not a limitation, promotions may be directly related to a prior transaction, indirectly related to a prior transaction, or targeted to a user based on card usage data which may indicate that a promotion (related or unrelated to past transactions) may be of interest to the user.

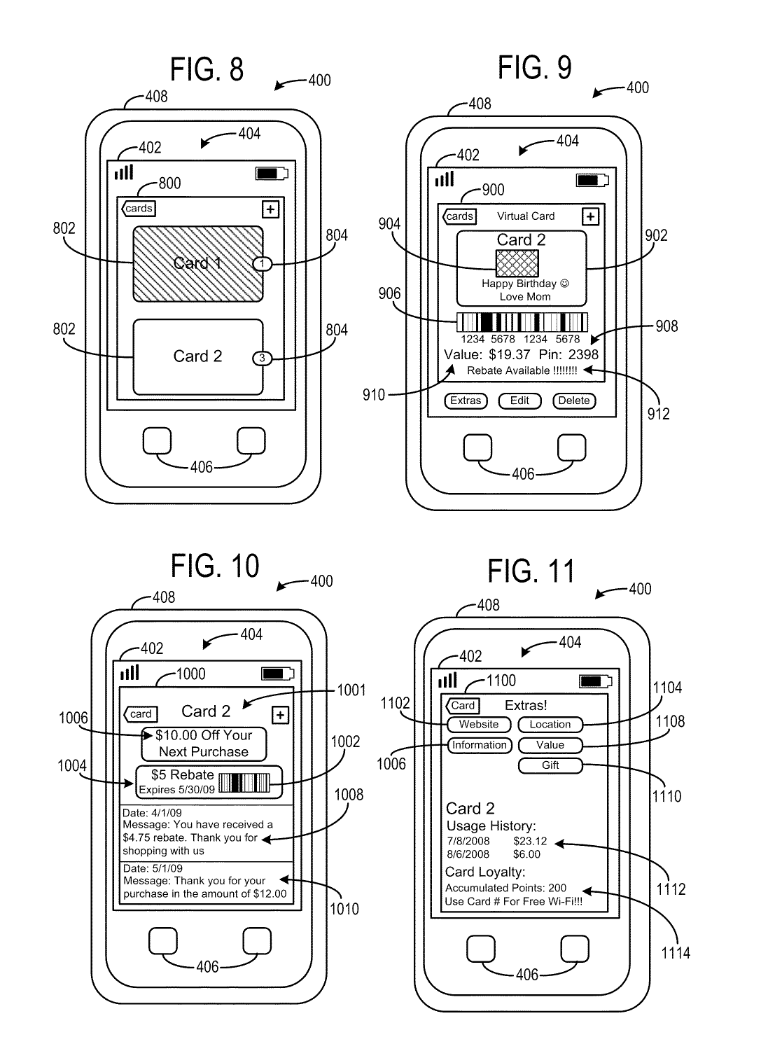

The virtual card engine may further include an arrangement module 206 configured to adjust the arrangement of two or more virtual cards based on predetermined virtual card criteria. In some embodiments, the predetermined virtual card criteria may include one or more of card usage data (number of transactions, date of transactions, etc.), card-type data, card value data, goods and services system data, and card expiration data. For example, a plurality of virtual cards may be arranged in descending order based on their expiration date. Further in other examples, a plurality of virtual cards may be arranged in an ascending order according to the amount of value associated with each card. It will be appreciated that numerous other arrangements are possible, in other examples. In this way, a user may quickly adjust the arrangement of the virtual cards include in the virtual card engine, allowing the user to quickly sort through the virtual cards and find a virtual card based on the criteria of the virtual card. Various virtual card arrangements are depicted in FIGS. 7 and 8.

The virtual card engine may further include a modification module, such as example, graphical modification module 208, configured to enable customization of the virtual card. For example, the graphical medication module 208 may be adapted to modify the appearance of at least one virtual card presented on a display of a mobile computing device. The appearance of the virtual card may include at least one of size, color, geometric configuration, and graphical characteristics (e.g. alpha-numeric data, images, logos, etc.). In other examples, the modification module may include customization by using sounds, video, pattern displays, etc. In this way, a user may customize and personalize the virtual card, thereby increasing customer satisfaction.

The virtual card engine may further include an update module 210 configured to adjust virtual card user data and send notification of adjustment to a virtual card manager. The virtual card user data may include an email address, a name, a phone number, etc. In some examples, the virtual card manager may be configured to send the virtual card user data to one or more card service providers. In this way, virtual card information stored within a card service provider may be kept up to date. Furthermore, the update module allows a user to update their card user data for a multitude of card service providers, saving the user time and energy.

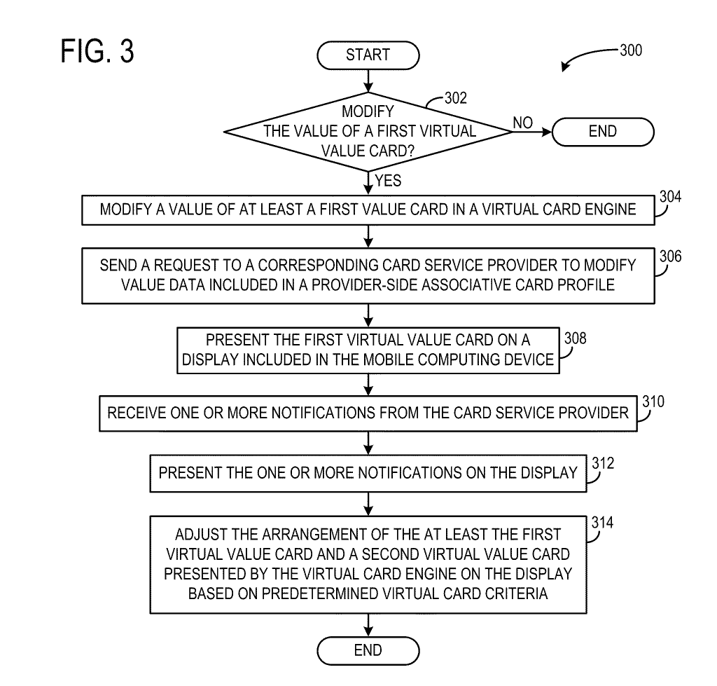

FIG. 3 shows an example method 300 for management of at least one virtual value card. In some embodiments, the method may be implemented utilizing the systems, devices, etc., described above. However, in alternate embodiments other suitable systems, devices, etc., may be utilized to implement method 300.

At, 302, the method includes determining if a request has been received by a virtual card engine to modify a value of a first virtual value card. In some examples, the virtual card engine may be executed on a mobile computing device. However in other examples, the virtual card engine may be executed on a remote Internet server. Further, it will be appreciated that the request may be generated in response to user input. However, in other embodiment the request may be automatically generated via the virtual card engine. Still further in some embodiments, the request may be sent through a virtual card manager to the card service provider. The virtual card manager may be configured to establish and authorize communication between the virtual card engine and the card service provider. If it is determined that a request has not been received (NO at 302) the method ends.

However, if it is determined that a request has been received (YES at 302) the method advances to 304 where the method includes modifying a value of at least the first virtual value card included in the virtual card engine. In some examples, the modification of the value may be based on user input. Furthermore, modifying a value of the first virtual value card may include at least one of dividing the value of the first virtual value card and combining the first virtual value card with a second virtual value card.

At 306, the method includes sending a request to a corresponding card service provider to modify value data included in a provider-side associative card profile. As previously discussed the provider-side associative card profile may include data corresponding to the first virtual value card. Next the method proceeds to 308 where the method includes presenting the first virtual value card on a display included in the mobile computing device.

Next at 310, the method may include receiving one or more notifications from the card service provider and presenting the one or more notifications on the display. In some examples, the notifications may be generated by the card service provider based on usage data of the first virtual value card tracked by the card service provider. Also, the one or more notifications may be promotional notifications and include at least one of value data, alpha-numeric data, graphical data, and audio data. However, in other examples the notifications may be other suitable notifications such as card-expiration notifications, card-usage notifications, etc. Next at 312, the method may include presenting one or more notifications on the display. In this way, a client may be notified of a number of promotional offers on via mobile computing device.

Next at 314, the method may include adjusting the arrangement of at least the first virtual value card and the second virtual value card presented by the virtual card engine on the display based on predetermined virtual card criteria. In some examples, the predetermined virtual card criteria may include one or more of virtual card usage data, card-type data, card value data, goods and services system data, and card expiration data. It will be appreciated that in some embodiments steps 310, 312, and/or 314 may not be included in method 300.

Method 300 allows a user to easily adjust a value of a virtual value card. In this way, a user may combine the value of two or more virtual value cards or split the value of a virtual value card. Such a method may not be implemented by a holder of a traditional plastic value card (e.g. gift card) having a value that can only be modified by a card service provider. Detailed methods which may be used to combine the value of two virtual value cards or split the value of a virtual value card are described in more detail herein with regard to FIGS. 14 and 15. Furthermore, method 300 allows a card service provider to transfer promotional notifications to a virtual card engine, allowing customers to receive special offers which may increase the sales of the goods and services system.

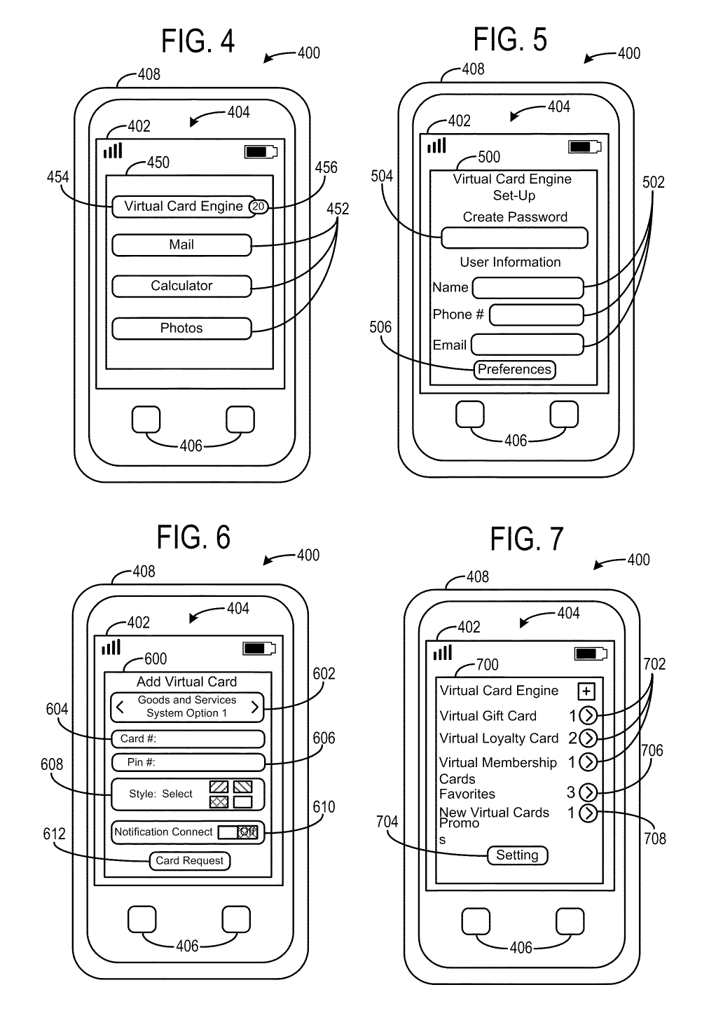

FIGS. 4-14 illustrate an example of mobile computing device 12 of FIG. 1, in the form of a mobile phone 400. Mobile phone 400 may include a display 402, which is analogous to display 20 of FIG. 1. The mobile phone may further include suitable input devices, such as a touch screen 404, various buttons 406, a keyboard (not shown) allowing a user to manipulate the mobile computing device. It will be appreciated that in some examples, the touch screen may present a keyboard to facilitate alpha-numeric input. Furthermore, various virtual card engine content windows are depicted in FIGS. 4-14, enabling a user to implement various functions of the virtual card engine. It will be appreciated that various buttons, touch inputs, etc., may be used to navigate between the content windows depicted in FIGS. 4-14. For example, a “back” button may be provided to allow a user to navigate to a previous window and a “plus” button may be provided to navigate to a content window that is configured to add a virtual card to a virtual card engine. Furthermore, a touch input performed above various graphics, icons, etc., may enable access of the features corresponding to the selected graphic or icon.

In particular FIG. 4 shows an illustration of an access-point content window 450 including various software applications access points 452 such as a mail application, a calculator application, and a photo application access point. The access points may be provided on the computing device as icons or other display units to enable a user to select the application. In one example, a user may trigger an access point via an input to access the selected application. It will be appreciated that the applications are exemplary in nature and that alternate or additional applications access points may be provided in other embodiments. The software applications may be stored on memory and executed via one or more processors. The memory, processor, as well as additional electronic componentry may reside within or on-board a device body 408 of mobile phone 400. The software application access points may further include a virtual card engine access point 454. The virtual card engine may be stored in memory for achieving the functionality described above via one or more processors. A notification identifier 456 may also be presented on the access-point content window 450. The notification identifier may alert a user of notifications which have been received by the virtual card engine. As described in more detail below, the alerts or other indicators may provide notice regarding new virtual cards added to the a virtual card wallet, alerts regarding possible improper use of a virtual card, alerts regarding a change in status of a virtual card, alerts regarding new promotional or other related information relative to the virtual cards, etc. In some systems, the user may select and set which alerts are displayed on the mobile computing device.

In some examples, the virtual card engine may be accessed via a browser. Thus, a browser-based virtual card engine may be utilized in some embodiments. For example, the browser-based virtual card engine may be utilized when memory requirements of the virtual card engine cannot be supported by the mobile phone.

When a browser-based virtual card engine is used, a card service provider or associated goods and services system may manage various characteristics of the virtual card. Therefore, a card service provider may adjust the appearance of at least one virtual card based on various parameters (e.g. time, date, card type, card value, etc.) For example, the appearance (e.g. style) of a virtual card may be adjusted based on the season of the year or holidays (e.g. Halloween, Christmas, etc.). It will be appreciated that the aforementioned examples may also be implemented when the virtual card engine is executed via a mobile computing device. That is to say that the card service provider may manage various characteristics of a virtual card included in a virtual card engine executed via a mobile computing device. In such an example, a card service provider may send a message requesting adjustment of the characteristics (e.g. appearance) of a virtual card and the mobile computing may accept or decline the request.

Furthermore, a portion of the virtual card engine may be executed via client-side software and a portion may be executed via browser-based software, in some embodiments. That is to say that a first set of functions performed by the virtual card engine may be managed via a browser-based application and a second set of functions performed by the virtual card engine may be managed via an application executed on the mobile computing device, the first set of functions are different from the second set of functions. Management of a virtual card engine functions may include implementation as well as modification of a virtual card engine function.

In particular, a user may manage backup methodologies via a browser-side portion of the virtual card engine, facilitating transfer of backup methods between mobile computing devices if a switch between devices is desired. Additional virtual card control features such as the value modification module and the notifications module, may be executed by the browser-side portion of the virtual card engine. However, in other embodiments, control features may be executed by the browser-side portion of the virtual card engine.

Returning to the figures, FIG. 5 provides an illustration of a virtual card set-up content window 500 which may be used to set-up a virtual card engine on mobile phone 400. It will be appreciated that numerous techniques may be utilized to set-up a virtual card engine on the mobile phone or other suitable mobile computing device and the depicted technique is exemplary in nature.

A user may enter various types of information into the mobile phone via input fields 502. As depicted the information may include one or more of user identification information (e.g. name, mobile number, email), into the mobile phone. However, in other examples additional or alternate user information may be used. The identification information may be sent to the virtual card manager and/or the card service provider to establish an account, such as a manager-side and/or provider-side associative card profile. The identification information allows the virtual card manager to obtain metrics about one or more virtual cards. Further, in some systems, the identification information may be captured by the virtual card manager to enable authentication and use of the virtual cards.

In some examples, a user may be prompted to set up at least one password for the virtual card engine via a password input field 504 to provide security for the mobile phone. Additional levels of security may be included depending on the requirements of at least one of the mobile phone, the virtual card manager, the card service provider, and the goods and services system.

Additionally, a user may be prompted to input additional data, such as virtual card engine preferences. The virtual card engine preferences may be accessed via access point 506. For example, the virtual card engine preferences may include preferences regarding the way in which the virtual cards are displayed (e.g. appearance and arrangement of the virtual cards), notifications (e.g. alerts, messages) received by the virtual card engine, and indicators presented by the virtual card engine. Further, a user may additionally be prompted to input data regarding their login preferences for the virtual card engine. It will be appreciated that a keyboard (e.g. touch-screen keyboard, mechanical keyboard) or other suitable input device may be utilized to input the aforementioned data.

It will be appreciated that the user information (e.g. name, phone number, email, etc.) may be adjusted after the virtual engine is set-up which may be tracked by the goods and services system or card service provider, depending on the preferences set-up via the virtual card engine. In particular, a user may be queried or requested to select a preference regarding updating user information within the goods and services system or card service provider. Therefore in some examples, the user information may be sent to the goods and services system or card service provider after the user information is adjusted via the virtual card engine. In this way, user information may be efficiently updated and propagated throughout the virtual card management system, which may save a user a considerable amount of time when compared to a system which may require the user to update the user information multiple times. Therefore, a goods and services system may maintain up to date record for loyalty or membership programs. Up to date records enable communications, such as mail solicitation or membership related mailings, to reach the user. In some examples, the virtual card engine may be configured to select the goods and services system that can receive updates to protect a user's privacy.

Various techniques may be used to add a virtual card to the virtual card engine. In some embodiments, a virtual card may be sent to the virtual card engine from the card service provider via the virtual card manger. For example, a virtual card may be generated via the card service provider, sent to the virtual card manager, and then subsequently uploaded by the virtual card engine. As previously discussed, generation of the virtual card may include purchasing a virtual card, in some embodiments. However in other embodiments, the virtual card may not be purchased. Further, it will be appreciated that the virtual card manager may allow or disallow uploading of the virtual card based on the predetermined preferences.

In other embodiments alternate techniques may be used to generate and transfer the virtual card to the virtual card engine. For example, as depicted in FIG. 6, a virtual card may be added to the virtual card engine via manual input of the virtual card data via a virtual card addition content window 600. Such a technique may be used when a plastic card is transferred into a virtual card via the virtual card engine. In particular, a user may be prompted to select a goods and services system via a selection field 602 that is associated with the virtual card. In other examples, the user may select a goods and services system or alternatively a card service provider from a searching function on the mobile computing device in order to find the goods and services system. Depending on the available goods and services systems and/or virtual card type, different searching methodologies may be employed.

Continuing with FIG. 6, the user may be prompted to enter various virtual card data. For example, as depicted a card number field 604 and a personal identification number (PIN) field 606 may be provided. Different types of card may require a different sets or subset virtual card data to identify a virtual card and/or secure the virtual card. Consequently, a user may be prompted to select type of virtual gift card, in some examples.

Further, a user may be prompted to select a virtual card style via a style field 608. A virtual card style may include a set of predetermined appearance characteristics such as, color, pattern, graphic layout, geometry, size, etc., of the virtual card presented on a display. It will be appreciated that in other examples, each appearance characteristics of the virtual card may be individually adjusted. The adjustment may be implemented via a graphical adjustment module, as discussed above with regard to FIG. 2. Furthermore, a user may adjust the appearance characteristics of the virtual card after the virtual card is added to the virtual card engine. In this way, a user may customize the appearance of the virtual card according to their predilection. However, in other examples, adjustment of the graphical characteristics of the virtual card may be inhibited.

Still further, a user may be prompted to allows or disallow the receipt of notifications via a “notification connect” button 610. It will be appreciated that at least one of the virtual card manager, the card service provider, and the goods and services system may generate the notifications. The notification may include promotional notifications such as rebate notifications, coupon notifications, or notifications regarding a change in the goods and services system's features. Furthermore, the notification connect button may also be configured to allow or disallow the transfer of user information (e.g. address, name, email) to the virtual card manager and/or the card service provider. However, in other examples, the “notification connect” button 610 may not be configured to allow or disallow the transfer of user information. The notification connect button may be generated by a notifications module and/or an update module, as discussed above with regard to FIG. 2. Further, in some examples, the “notification connect” may be setup to allow for different levels of communication and may include a more detailed setup screen to disallow specific types of communication while allowing other types of communications.

Further in some examples, a card request may be enabled via selection of a card request button 612, as depicted in FIG. 6. In such an example, a user may request a virtual card from a goods and services system and/or a card service provider through the mobile phone. In some examples, the card service provider may permit the request based on the verification of the mobile phone through the virtual card manager. However, in other examples, the card service provider may permit the request based on different policies. In some examples, the mobile phone may be directed to a browser application that is configured to perform a virtual card request from the goods and services system and/or card service provider. Moreover, the goods and services system may receive payment and/or registration information for a virtual card through the browser application. However, it will be appreciated that some virtual cards may not require payment. In response to successful registration the virtual card may be automatically added to the virtual card engine or a unique code may be sent to the virtual card engine which will be recognized by the virtual card engine in order to add the virtual card and provide an extra level of security. For example, the user may not have initiated the request from a computing device that is valid to the virtual card engine and a code may be provided to enable the user to add the virtual card to a selected mobile computing device.

FIG. 7 shows an illustration of a virtual card management window 700. As depicted, access may be provided, via access points 702, to various virtual card types (e.g. gift, loyalty, and membership cards). In this way, the arrangement of the virtual cards may be adjusted based on card-type data. In the illustrated example, the virtual card engine or wallet includes one virtual gift card, two virtual loyalty cards, and one virtual membership cards as well as three cards in a favorite folder and one promotional virtual card. It will be appreciated that the arrangement of the virtual cards may be adjusted based on additional or alternate virtual card criteria. The virtual card criteria may include one or more of card usage data (number of transactions, date of transactions, etc.), card value data, goods and services system data, and card expiration data. For example, virtual cards having a value over a threshold amount may be presented on the display or the virtual cards that have been used for a transaction in the past X number of days, hours, etc., may be presented on the display. In this way, a user can quickly and efficiently access virtual cards that they are likely to use.

Furthermore, the virtual card engine content window may provide a link 704 to enable a user to reconfigure the setting of the virtual card engine. For example, a user may update their previously configured setting, including user information and user preferences.

An access point 706 to a “favorites” listing or folder may also be provided. For example, a user may select a “favorites” folder, similar to selection of such a folder in a browser. A user may identify one or more cards as favorite cards. For example, a user may identify a highly frequented gym membership card as a favorite card. The selection of the “favorites” folder may allow the user to quickly display a selected virtual card. It will be appreciated that alternate types of virtual cards may be selected for the “favorites” folder. Further in some examples, a user may select to hold some number (e.g. 4 or 5 cards) of their most frequently used virtual cards in the favorite folder. However, in other examples virtual cards may be added to the “favorites” folder via other suitable techniques.

Further in some examples, a “promos” folder access point 708 may be provided on virtual card management window 700. The “promos” folder may allow a user to select from a list and/or search different goods and services systems or card service providers and request virtual promotional notifications from selected goods and services systems or card service providers. It will be appreciated that the promotional notifications may include virtual promotional items. The virtual promotional items may include promotional virtual gift cards, promotional virtual offer cards (e.g. $10 off your next purchase), or other suitable virtual promotional items. In other examples, the promotional notifications may include links to the virtual promotional items. In some examples, the virtual promotional items may be provided to previously identified users. In other examples, the virtual promotional items may be sent by a goods and services system or card service provider to a virtual card engine that does not have a membership with the card service provider or goods and services system. Further in some examples, the virtual promotional items may require that the virtual card engine provide user data to receive the virtual promotional items.

For example, a goods and services system may utilize user data to adjust the type of virtual promotional item sent to the virtual card manager. Moreover, user data may provide metrics and feedback regarding promotions and services offered by the goods and services system or card service provider. However, it will be appreciated that in other embodiments the virtual promotional items may not require user data from the virtual card engine.

In some examples, a Merchant Connect selection may be available. The Merchant Connect selection may enable a user to select whether a merchant is able to send and receive second level user updates. The second level updates may include promotional materials, update of user information into merchants systems (such as change of addresses and the like).

In some systems, a membership request may be enabled. For example, a user may select “No Card—I want to request membership”. In such examples, a user may request membership with the merchant through the mobile device. The user may be directed to a browser application or built in application that allows that user to request membership directly with the merchant, the merchant's card processing service and/or card service provider. Because the request is coming from a verified device through the virtual card manager, the merchant may allow for users to sign up for their cards in this manner. The merchant may also receive payment or other funds by taking them through their signup process. Upon successfully registering, the card may be automatically added to the wallet (user's account), or a unique code may be granted which will be recognized by the wallet in order to add the card and provide an extra level of security. For example, the user may not have initiated the request from a device valid to the user's account and a code may be provided to enable the user to add the virtual card to a select device.

As an example, a virtual card and/or a virtual card use may trigger adoption or receipt of a loyalty and/or membership card. For example, a user after using the value on the virtual gift card may then be requested whether the user would like to receive a virtual loyalty card. In other systems, the virtual gift card may automatically trigger a virtual loyalty card with little or no user input. As such, the system enables the transformation of an expired or used virtual gift card into a virtual loyalty and/or membership card. In other systems, the virtual gift card may not need to be expired to trigger the offering or receipt of a virtual membership or loyalty card.

FIG. 8 shows an illustration a virtual card management window 800 which may be used to sort through virtual cards included in the virtual card engine. It will be appreciated that the virtual card content window may be configured in a number of ways to allow a user to sort through the virtual cards. As shown, visual depictions 802 of a plurality of virtual cards may be presented on the screen. In another example, the virtual card may be presented in a list or other form that allows a user to sort through the virtual cards.

In some examples, the visual depictions of the virtual cards may include notification identifiers 804. The notification identifiers may alert a user of the notification received by the virtual card engine corresponding to an individual virtual card. In the depicted embodiment, the notification identifiers are numbers signifying the amount of notifications corresponding to the virtual card. However, it will be appreciated that alternate notification identifiers having alternate appearances may be used in other embodiments. For example, the notification identifiers include text pertaining to a notification. As previously discussed notifications may include information regarding promotions, offers, specials, merchant hours, transactional data, expiration warnings, security notifications, etc.

FIG. 9 shows an illustration of a virtual card content window 900 which may be accessed to transfer virtual card information to a goods and services system via scanning or other another suitable technique such as wired data transfer or wireless data transfer (e.g. Bluetooth, infrared). In this way, a user may access one or more virtual cards via the virtual card engine and transfer card data to a card service provider to implement a virtual card transaction with the virtual card provider. However it will be appreciated that other suitable techniques may be utilized to implement a virtual card transaction.

A depiction of a physical card representation 902 may be presented on the display. As shown, the appearance physical card representation may be adjusted (e.g. customized). For example, the depicted card includes the text “happy birthday”. However, it will be appreciated that the appearance of the virtual card may be adjusted in alternate way, as discussed above. In addition to the appearance, the card may be customized for color selections, formatting, sounds, videos, pictures, etc. For example, a virtual card may play the song happy birthday upon display of the card. The giver of the card may be able to customize the card or select the customization to enhance the experience of receiving the gift card. Further, the recipient may also be able to customize or selectively customize aspects of the gift card.

In the example of the Happy Birthday message, the virtual card may be customized by the virtual card giver such that the virtual card giver is identified or a message is linked with the virtual card. For example, a message such as “happy birthday—love mom” may enable a recipient to remember the identity of the giver of the virtual card. The card giver may select to put a full name, address, or other message to enable the recipient to know the source of the card. Such giver customization may improve the experience for a giver in regards to being able to provide a gift (a virtual card) which is personalized. Further, many times plastic gift cards are held for a long period and the original giver of the card is forgotten. A recipient upon use or viewing of the card may be provided with information regarding the source of the virtual card. Further in some systems, the giver of the card may receive feedback regarding the recipient's use of the virtual card.

In some examples, merchants may also provide promotional add-ons for the virtual card user such that the virtual card user's experience is enhanced. As one example, merchants may select to issue seasonal cards, either automatically, or to allow users to select from seasonal cards with the selection capabilities of the device. For example, the merchant may automatically wish to load a Halloween card to certain card carriers for use of the virtual card on that day. The merchant may also allow for users to select from different seasonal cards that are generally available to the user and are not necessarily issued from the merchant. This allows the user to select from several potential designs for their card. The authentication is not based on the visual presentation of the card, but rather on the authentication methods of using that card from the proper device. As such, customization of the visual appearance of the card may be available as merchant add-ons, as user selections, etc.

As another example, it should be appreciated that a user or merchant could attach voice, text, music or video to go along with the delivery and/or presentation of their virtual card. These enhancements may provide an attachment or addition to the virtual card to remind the virtual card user who gave them the card, or to further enhance the experience of the use of that virtual card. Examples of enhancements include receiving a customized voice message with the card that can be played by the user or is automatically played when the user views the card.

An identification picture 904 may also be included in the physical card representation. In some examples, the goods and services system or card service provider may require an identification picture. In other examples, the identification picture may be user selectable. For example, the identification picture may be automatically updated by the user should they wish to add their picture to their virtual card. The identification picture may be presented on the virtual card may also be controlled by the card service provider or the goods and services system, thereby adding an extra layer of security to the virtual card. In some examples, the virtual card manager may provide functionality for an initial identification picture update. In some examples, a single identification picture may be used for two or more virtual cards. In further examples, the identification picture may be stored in the card service provider or the goods and services system. However, in other examples an identification picture may not be used.

For some goods and services systems, depending on the level of security, the identification picture of the individual representing that member card, which may be locked for alternations, along with card coding, and/or periodic mobile authentication methods may provide a secure approach for redemption of the virtual cards. However, it should be appreciated that additional security measures may be implemented depending on the goods and services system.

Additionally, a barcode 906, a PIN 908, and value data 910 may also be presented on the display. In some systems, some of the virtual card data may be in a hidden state until use request for use. However, in other systems, the virtual card data may be available for viewing at all times. Furthermore, a notification 912 may also be presented on the display in some examples. However, alternate or additional virtual card data may be presented on the display, in other examples.

The notification regarding a rebate or coupon may alert a user to availability of such promotions and/or alerts regarding expiration of virtual cards, rebates or coupons. Such information may also be presented in a message such as the messages shown in FIG. 10. Thus, a user may be able to manage the availability and expiration of the virtual cards, related promotional items, etc.

Furthermore, various input functions may enable the virtual card to be customizable such that a user can alter the appearance or display of virtual card data. For example, a user may be able to change the size of the virtual card data and associated images (e.g. physical card representation, barcode). For example, the barcode may be zoomed in to allow user to scan the barcode at a goods and services system. In some systems, a scale (not shown) may be provided to indicate the size the merchant coding (e.g. bar code) must be expanded for use. For example, a user may select various scales associated with each virtual card, allowing the barcodes to be scanned by different card service providers.

In one example, a user action such as requesting use of a virtual card may affect presentation of virtual card data (such as a bar code, a pin code, a password, etc.) and in some systems the request to use a virtual card may also trigger the toggling of the status of the card. Thus, in such systems, an action such as flipping an electronic card over or accessing a bar-code region or other code may trigger the toggling of the status of the card. For example, in some embodiments, a virtual card may be presented on the user computing device and an action such as flipping the card over electronically may enable a user to “see” the reverse side of the card where a barcode or other use information may be stored. The action of flipping the card over may trigger the enabled state. The card may then remain in the enabled state for a predetermined period of time such that failure to use the card during a defined period of time results in the card toggling back to the disabled state. In other embodiments, once enabled, the card may stay in the enabled state indefinitely or until another action, such as a closing of the virtual card occurs or a time limit is reached.

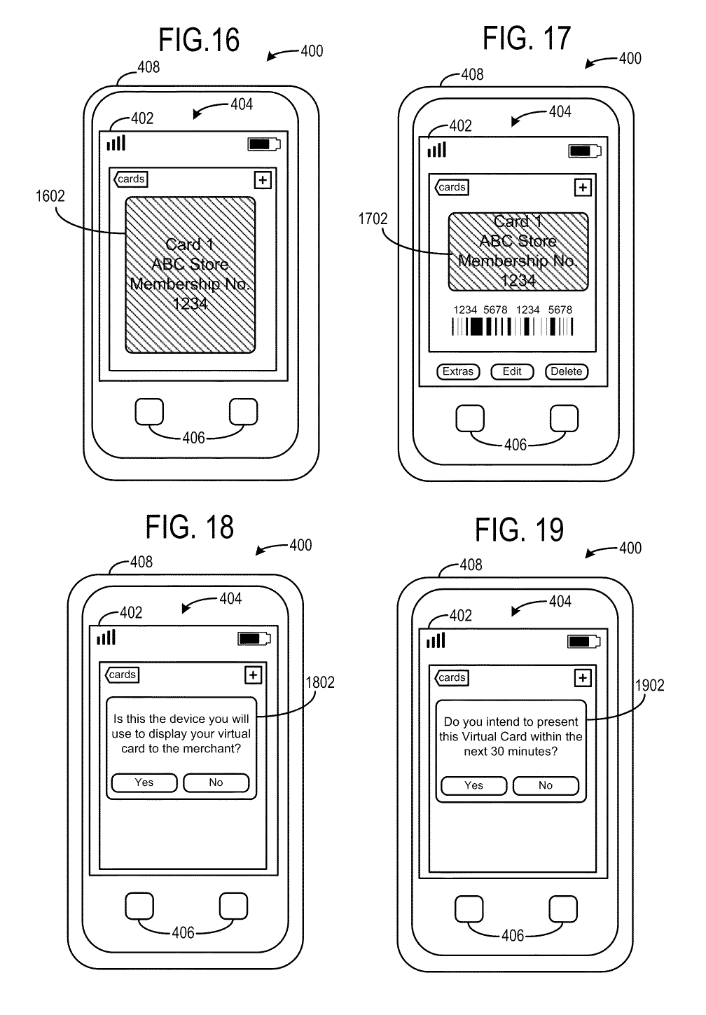

As an example, FIGS. 16 and 17 illustrate a mobile computing device with a membership card in a first configuration and a second use configuration. Specifically, FIG. 16 illustrates a virtual membership card in a first configuration 1602 where the virtual membership card includes at least some virtual card data for identification purposes of the virtual card. FIG. 17 illustrates virtual membership card 1602 after a request for use (such as an action to flip the card over). Although described in regards to flipping the card over, over requests for use, such as a user input request or other action to request use, may change the display of the card. For example, at 1702 a second configuration is shown where a bar code is included for use by Store ABC. The action of flipping the card over or otherwise requesting use may toggle the card into an enabled state.

FIG. 10 shows an illustration of a virtual card content window 1000 on which a plurality of notifications 1001 may be presented. The notifications may be generated relative to any party involved in virtual card management system (e.g. goods and services system, card service provider, POS system, virtual card manager, etc.) and may include promotional notifications and transaction notifications, as discussed above. In some examples, the virtual card manager may connect third party systems to the virtual card manager, or may provide direct functionality to add notifications through the goods and services systems. However, in other examples a different technique may be used to add notifications.

The promotional notifications may include value data which may be used to implement a virtual card transaction to receive a discount. As depicted the notifications may include data such as barcodes 1002, value amounts 1004, dates 1006, messages 1008, etc., allowing a user to directly receive the rebate or incentive. However, other promotional notifications may include links to rebates or incentives. In this way, a goods and services system may provide a client with special offers and incentives to purchase items within their system as well as other pertinent information, thereby maintaining a loyal customer base as well as increasing their sales. In some systems, a survey or other user input may be requested and tied to a rebate or other promotional offering.

Additional notifications that may be presented in the content window may include transaction notifications 1010 that include information regarding a virtual card transaction such as the date of a purchase and the amount of monetary value used in the transaction. It will be appreciated that the aforementioned notifications are exemplary in nature and that additional or alternative notifications providing alternate offers and/or functionality as well as having a different appearance (e.g. size, color, alpha-numeric layout, graphics, etc.) may be provided in other embodiments.

Further in some examples, the promotional offers may be deleted or graded according to a predetermined scale. This type of feedback relative to offers, and more specifically relative to a specific user and the related offer can help the goods and services system determine which users are most interested in certain offers, as well as provide feedback to the quality of promotional or other offers. Location information such as known zip codes/addresses can also help determine the presentation of notifications. For example, store hours, phone or other details of the closest store can be made available relative to a virtual card.

FIG. 11 shows an illustration of a virtual card content window 1100. As depicted, access may be provided to virtual card features and/or goods and services system features corresponding to a virtual card in the virtual card engine. For example, the virtual card and/or goods and services system features may include, but are not limited to, a website link 1102 allowing a user to access a goods and services system's website. The features may further include a location link 1104 allowing a user to view the locations of various goods and services system's outlets (e.g. brick and mortar stores). The location link may also include in some examples, reviewing of the outlets and data related to the outlets. Additionally the features may include an information link 1106 providing the user with hours, promotions, offering, and access to notifications (e.g. messages). A value link 1108 and a gift link 1110 may also be provided in some examples. The value link may allow a user to add value to a virtual card and the gift link may enable a user to send a virtual card to another virtual card engine. In some examples, when the virtual card engine has been set-up the virtual card features may be provided through the virtual card engine. However in other examples, the virtual card features may be provided through another suitable system.

Virtual card usage history 1112 may also be displayed, the virtual card usage history corresponding to a selected card. The virtual card usage history may include usage data such as a date of a transaction, a transaction amount, a location where the transaction was implemented, etc. Furthermore, loyalty data 1114 may be displayed. The loyalty data may include value data (e.g. points) as well as messages pertaining to promotional offers.

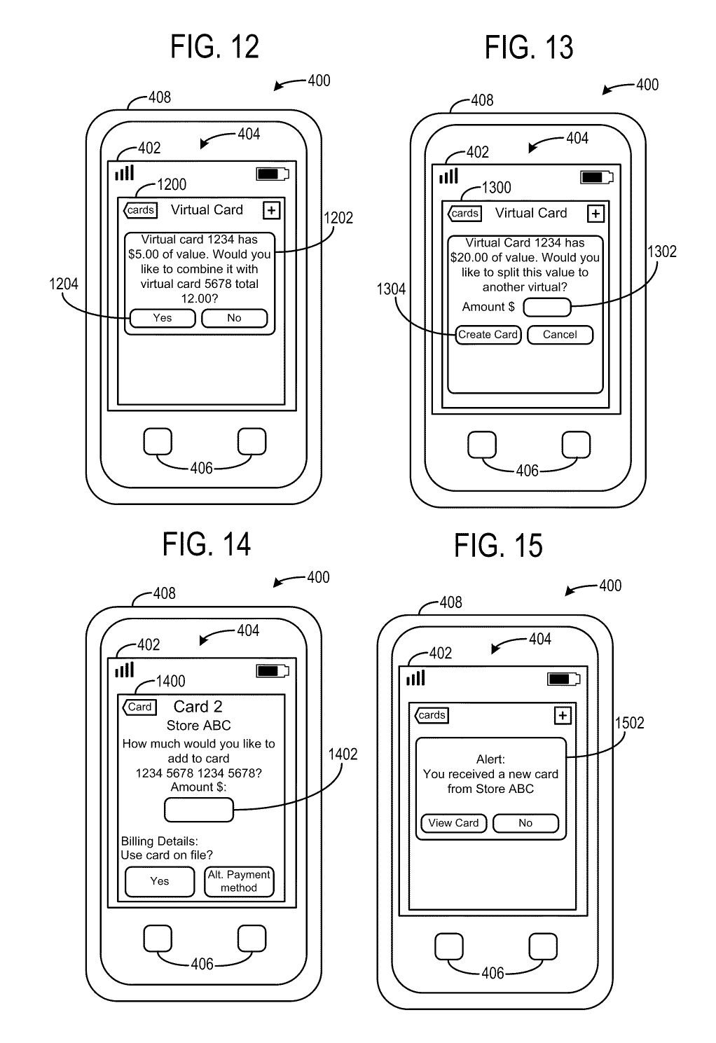

FIG. 12 shows a virtual card content window 1200 that may be used to combine two virtual value cards. It will be appreciated that a user may select two or more virtual cards to combine. As depicted, a user may be prompted to combine the value of two virtual value cards. A button 1204 may be used to combine the two selected virtual value cards. However, it will be appreciated that alternate techniques may be used to combine two virtual value cards in alternate embodiments. Furthermore, it will be appreciated that in other embodiments value from a plurality of virtual value cards may be combined. In this way, a user may consolidate virtual cards in the virtual card engine. A method used to combine two or more virtual value cards card is described in more detail with regard to FIG. 15.

FIG. 13 shows a virtual card division content window 1300 which may be used to split a value on a virtual card, thereby creating a new card. As depicted a user may be prompted to input a value amount into field 1302. A button 1204 may also be provided to create a new value card. Therefore, a user may enter an amount into the entry field and then trigger button 1304 to divide the value of a virtual value card by a chosen amount and create a second virtual value card. However, it will be appreciated that numerous approaches may be used to split a virtual value card and the depicted approach is exemplary in nature. A method used to split the value of a virtual value card is described in more detail with regard to FIG. 16.

FIG. 14 provides a virtual card management window 1400 which may be used to add value to a virtual value card. As depicted a value field 1402 may be provided for a user to enter an amount of value they would wish to add to the virtual card. It will be appreciated that a credit or debit card may be stored on file, allowing a user to quickly add value to a virtual value card. It will be appreciated that in some embodiments value may be added to a virtual card via a browser-based virtual card engine. However, in other embodiments a client-based virtual card engine may be used to add value to a virtual value card. In this way, a virtual value card may be added to the virtual card engine.

FIG. 15 provides an example notification or alert 1502. As described above, the alert may provide notice regarding new virtual cards added to the a virtual card wallet, alerts regarding possible improper use of a virtual card, alerts regarding a change in status of a virtual card, alerts regarding new promotional or other related information relative to the virtual cards, etc. In some systems, the user may select and set which alerts are displayed on the mobile computing device. The alert may include information regarding the identity of a virtual card such that a user may select whether or not to view the virtual card. Messages, as described above, may also be sent via an alert.

Although briefly described above, FIGS. 18 and 19 provide example displays for a browser-based solution. In the browser-based solution, a user may access the features described in regards to the virtual cards through a computing device, not necessarily the mobile computing device which will be used to present the virtual card. A user may opt to use the browser-based solution in order to more effectively manage the virtual card wallet or to link the virtual card wallet with other programs or data. Further, some users may prefer the browser-based solution due to screen size, ease of use, etc. Regardless of whether using the browser-based solution or the mobile device solution, both an established virtual card account is established and authenticity verified.

In some examples, it is noted that in the browser-solution the user may not be able to as quickly get into the application in order to show the virtual card while at the merchant's Point of Sale. For example, with a browser-based solution, a virtual card may have been delivered, but not be relative to an account. The ability to not define an account may be based on the merchant's rules for their virtual card program. In the illustrated example, the user has not established an account; therefore the card may request the user in regards to whether this device is the device that will be used to display the virtual card at 1802. In this example, the browser may create a cookie (or other identifiable indicator as provided by the associated browser functionality) per the user answering the request question to authenticate the virtual card to the selected device.

FIG. 19 provides an example user mobile computing device display with a virtual card displayed in a browser-based environment. The display at 1902 requests that the user confirm that the virtual card is intended to be presented. The user is thus being requested to authenticate the use of that virtual card prior to allowing the display of the card.

This is an example of functionality that may happen with either an account established browser solution or a non-account established solution. The features may depend on the merchant's setup of their virtual card program and what the merchant's tolerances are. Once the presentation intention is confirmed, the virtual card may be presented on the mobile computing device.

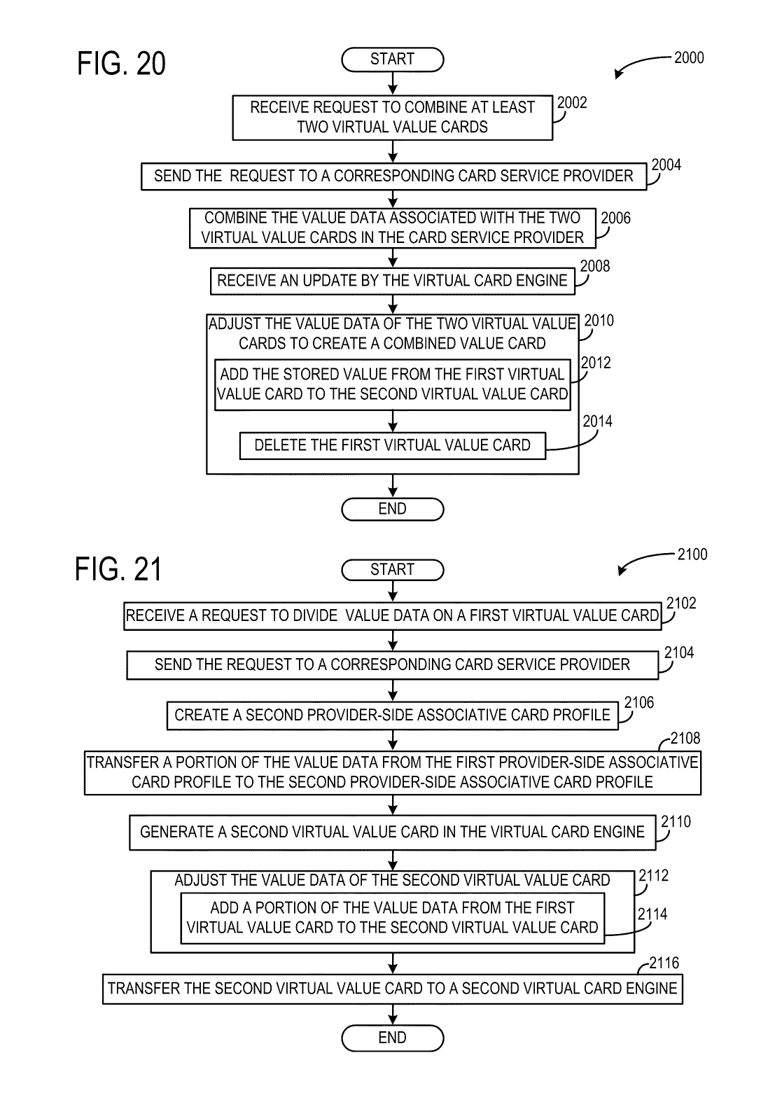

FIG. 20 shows a method 2000 which may be used to combine two virtual value cards. In some embodiments, the method may be implemented utilizing the systems, devices, etc., described above. However, in alternate embodiments other suitable systems, devices, etc., may be utilized to implement method 2000.

At 2002 the method includes receiving a request to combine at least two virtual value cards. In some embodiments the request may be generated via a virtual card engine in response to a user input. However, in other examples, the virtual card engine may automatically combine two or more virtual cards.

Next at 2004 the method includes sending the request to a corresponding card service provider. The corresponding card service provider may be configured to implement a virtual card transaction with the virtual value cards, in some examples. Further in some examples, the request may first be sent to a virtual card manager and then to the corresponding card service provider. As previously discussed, the virtual card manager may act as an intermediary between the virtual card engine and the card service provider. Thus, the virtual card manger may facilitate communication between two systems utilizing different communication methods (e.g. protocols). However in other examples, the request may be directly sent to the associated card service provider.

Next at 2006 the method includes combining the value data associated with the two virtual value cards in the card service provider. Combining may include adding the value data associated with a first virtual value card to value data associated with a second virtual value card and subsequently deleting the value data associated with the first virtual value card. The value data associated with the first virtual value card may be stored on a first provider-side associative card profile and the value data associated with the second virtual value card may be stored on a second provider-side associative card profile. However, it will be appreciated that alternate techniques may be used to combine the value data in other embodiments.

Next at 2008 the method includes receiving an update by the virtual card engine. The update may include information regarding success of the request as well as additional data, such as card information data, authentication data, etc. In some examples, the card service provider may generate the request update and sent the request update to the virtual card manager which transfers the information to the virtual card engine.

Next at 2010 the method includes adjusting the value data of the two virtual value cards to create a combined value card. It will be appreciated that step 2010 may be implemented via the virtual card engine. In some examples, adjusting the value data of the two virtual value cards to create a merged value card may include at 2012 adding the stored value from the first virtual value card to the second virtual value card and at 2014 deleting the first virtual value card. Thus the first virtual value card may be the combined value card. It will be appreciated that alternate techniques may be utilized to adjust the value data of the two virtual value cards to create a merged value card. For example, a third virtual value card may be generated and the value data from the first and second value cards may be added to the third virtual value card. Subsequently, the first and second value card may be deleted. In this way, two or more virtual value cards may be merged, allowing a user to consolidate a portion of the virtual cards included in the virtual card engine.

FIG. 21 shows a method 2100 which may be used to divide the value of a virtual value card. In some embodiments, the method may be implemented utilizing the systems, devices, etc., described above. However, in alternate embodiments other suitable systems, devices, etc., may be utilized to implement method 2100.

At 2102 the method includes receiving a request to divide value data on a first virtual value card. In some embodiments the request may be generated via a virtual card engine in response to a user input. However in other examples, the virtual card engine may automatically divide the first virtual value card.

Next at 2104 the method includes sending the request to a corresponding card service provider. The corresponding card service provider may be configured to implement a virtual card transaction with the virtual value cards. In some examples, the request may first be sent to a virtual card manager and then to the corresponding card service provider. As previously discussed, the virtual card manager may act as an intermediary between the virtual card engine and the card service provider. Thus, the virtual card manger may facilitate communication between two systems utilizing different communication methods (e.g. protocols). However in other examples, the request may be directly sent to the associated card service provider. Furthermore, the card service provider may include a provider-side associative card profile which corresponds to the first virtual value card.

Next at 2106 the method includes creating a second provider-side associative card profile and at 2108 includes transferring a portion of the value data from the first provider-side associative card profile to the second provider-side associative card profile.

Next at 2110 the method includes generating a second virtual value card in the virtual card engine. It will be appreciated that the card service provider may trigger the generation of the second virtual value card, in some examples. However, in other examples, a goods and services system or a POS system may trigger generation of the second virtual card.

Next at 2112 the method includes adjusting the value data (e.g. stored value) of the second virtual value card. Adjusting the value data may include adding a portion of the value data from the first virtual value card to the second virtual value card at 2114. The portion of the value data added to the second virtual value card may be equivalent to the portion of value data transferred from the first provider-side associative card profile to the second provider-side associative card profile. However it will be appreciated that other methods may be used to adjust the value data in other embodiments. In this way, the value of a virtual value card may be split, allowing a user to modify the virtual card according to their needs, thereby enabling greater customization of virtual cards included in the virtual card engine.

Further in some examples the method may include at 2116 transferring the second virtual value card to a second virtual card engine. In this way, a user may be able to split the value of a virtual card and then send the new virtual value card as a gift to another person. Such a method is not possible with a plastic value card whose value is fixed and cannot be adjusted after generation. However it will be appreciated that in other embodiments step 2116 may not be included in method 2100.

The systems and methods described above allow a user to quickly and efficiently manage a large number of virtual cards in a virtual card engine. In particular various functions such as adjusting the value, appearance, layout, etc. of a number of virtual cards may be implemented, allowing a user to customize the virtual cards, thereby increasing customer satisfaction.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein.

Inventions embodied in various combinations and subcombinations of features, functions, elements, and/or properties may be claimed in a related application. Such claims, whether they are directed to a different invention or directed to the same invention, whether different, broader, narrower or equal in scope to any original claims, are also regarded as included within the subject matter of the inventions of the present disclosure.

1. A virtual card engine stored on memory executable via at least one processor for managing at least one virtual card, the virtual card engine comprising:
a value modification module configured to modify value data corresponding to at least a first virtual card based on user input, send a request to an associated card service provider to modify value data in a corresponding provider-side associative card profile, and present the first virtual card on a display of a mobile computing device to initiate a virtual card transaction between the virtual card engine and the card service provider.

2. The virtual card engine of claim 1, wherein the request is sent through a virtual card manager to the associated card service provider, the virtual card manager configured to establish and authorize communication between the virtual card engine and the associated card service provider.

3. The virtual card engine of claim 1, wherein the value modification module is configured to combine two or more virtual cards.

4. The virtual card engine of claim 1, wherein value modification module is configured to generate a second virtual card and transfer a portion of the value data from the first virtual card onto the second virtual card.

5. The virtual card engine of claim 4, wherein the value modification module is further configured to transfer one or more of the first and second virtual cards to a second virtual card engine.

6. The virtual card engine of claim 1, further comprising a notifications module configured to receive and present one or more promotional notifications on the display, the promotional notifications corresponding to the first virtual card and an associated card service provider configured to process a virtual card transaction with the first virtual card.

7. The virtual card engine of claim 6, wherein the associated card service provider is configured to track and store virtual card usage data of at least the first virtual card and generate the one or more promotional notifications based on the usage data of the first virtual card.

8. The virtual card engine of claim 6, wherein a virtual card transaction includes a transaction between the associated card service provider and the virtual card engine in which value data stored in the associated card service provider is modified.

9. The virtual card engine of claim 7, wherein the promotional notifications include one or more of a rebate notification and an incentive notification, the rebate notification and incentive notification including at least one of value data, audio data, image data, and alpha-numeric data.

10. The virtual card engine of claim 1, wherein the virtual card engine is executed on the mobile computing device.

11. The virtual card engine of claim 1, wherein the virtual card is one of a gift card, a membership card and a rewards card.

12. The virtual card engine of claim 1, further comprising an arrangement module configured to adjust the arrangement of at least the first virtual card and a second virtual card presented by the virtual card engine on the display based on predetermined virtual card criteria, the virtual card criteria including one or more of card usage data, card-type data, card value data, goods and services system data, and card expiration data.

13. The virtual card engine of claim 1, further comprising a modification module configured to enable customization of at least the first virtual card presented by the virtual card engine on the display, including customization of at least one of size, geometric configuration, and graphical characteristics of the virtual card on the display.

14. A method for management of at least one virtual card, the method comprising:
modifying a value of at least a first virtual card included in a virtual card engine based on user input, the virtual card engine executed on a mobile computing device;
sending a request to a corresponding card service provider to modify value data included in a provider-side associative card profile; and
presenting the first virtual card on a display included in the mobile computing device;
wherein modifying the value of at least the first virtual card includes at least one of dividing the value of the first virtual card and combining the first virtual card with a second virtual card.

15. The method of claim 14, wherein the request is sent through a virtual card manager to the corresponding card service provider, the virtual card manager configured to establish and authorize communication between the virtual card engine and the corresponding card service provider.

16. The method of claim 14, further comprising receiving one or more notifications from the corresponding card service provider and presenting the one or more notifications on the display, the notifications generated by the card service provider based on usage data of the first virtual card tracked by the corresponding card service provider.

17. The method of claim 16, wherein the one or more notifications are promotional notifications and include at least one of value data, alpha-numeric data, graphical data, and audio data.

18. The method of claim 14, further comprising adjusting the arrangement of at least the first virtual card and the second virtual card presented by the virtual card engine on the display based on predetermined virtual card criteria, the predetermined virtual card criteria include one or more of virtual card usage data, card-type data, card value data, goods and services system data, and card expiration data.

19. A mobile computing device comprising:
a display;
memory executable via one or more processors;
a virtual card engine stored on the memory including;
a value modification module configured to modify value data corresponding to at least a first virtual card based on user input, send a request to an associated card service provider to modify value data in a corresponding provider-side associative card profile, and present the first virtual card on the display to initiate a virtual card transaction between the virtual card engine and the associated card service provider; and
a notifications module configured to receive and present one or more promotional notifications on the display, the one or more promotional notifications corresponding to the first virtual card and an associated card service provider configured to process a virtual card transaction with the first virtual card;
wherein the request is sent through a virtual card manager to the associated card service provider, the virtual card manager configured establish and authorize communication between the virtual card engine and the associated card service provider.

20. The mobile computing device of claim 19, wherein the associated card service provider is configured to track and store virtual card usage data of at least the first virtual card and generate the one or more promotional notifications based on the tracked and stored usage data of the first virtual card.

21. The mobile computing device of claim 19, wherein the one or more promotional notifications include at least one of a rebate notification and an incentive notification having value data.

22. The mobile computing device of claim 19, wherein the first virtual card is a virtual gift card, a virtual membership card, or a virtual loyalty card.

23. The mobile computing device of claim 19, further comprising an arrangement module configured to adjust an arrangement of at least the first virtual card and a second virtual card presented by the virtual card engine on the display based on predetermined virtual card criteria, the predetermined virtual card criteria includes one or more of card usage, card-type data, card value data, goods and services system data, and card expiration data.
